(19) United States
(12) Patent Application Publication
(10) Pub. No.: US 2014/0009784 A1
(43) Pub. Date: Jan. 9, 2014

(54) ELECTRONIC APPLIANCE, METHOD FOR CONTROLLING ELECTRONIC APPLIANCE AND NON-TRANSITORY COMPUTER READABLE MEDIUM

(71) Applicant: FUJI XEROX CO., LTD., Tokyo (JP)

(72) Inventor: Noriaki NARA, Kanagawa (JP)

(73) Assignee: FUJI XEROX CO., LTD., Tokyo (JP)

(21) Appl. No.: 13/790,802

(22) Filed: Mar. 8, 2013

(30) Foreign Application Priority Data
Jul. 5, 2012 (JP) 2012-151777

(51) Int. Cl. G06F 3/041

(52) U.S. Cl. CPC G06F 3/0412
USPC 358/1.15

(57) ABSTRACT

An electronic appliance includes: an apparatus main body; a display device provided in the apparatus main body, the display device being displaceable with respect to the apparatus main body or being detachable from the apparatus main body; a receiving unit provided in the apparatus main body to receive predetermined information from a user, the receiving unit including plural push portions that are activated when being pushed by a user; and a detector that detects displacement of the display device with respect to the apparatus main body or detachment of the display device from the apparatus main body, wherein, in a case where the displacement of the display device with respect to the apparatus main body or the detachment of the display device from the apparatus main body is detected by the detector, a screen for receiving the predetermined information from a user is displayed on the display device.

### CROSS REFERENCE TO RELATED APPLICATIONS

This application is based on and claims priority under 35 USC §119 from Japanese Patent Application No. 2012-151777 filed Jul. 5, 2012.

### BACKGROUND

1. Technical Field

The present invention relates to an electronic appliance, a method for controlling an electronic appliance and a non-transitory computer readable medium.

2. Related Art

Many apparatuses are known in which hard keys for inputting information or the like and an image of hard keys are used in combination.

### SUMMARY

According to an aspect of the present invention, there is provided an electronic appliance including: an apparatus main body; a display device that is provided in the apparatus main body, the display device being displaceable with respect to the apparatus main body or being detachable from the apparatus main body; a receiving unit that is provided in the apparatus main body to receive predetermined information from a user, the receiving unit including plural push portions that are activated when being pushed by a user; and a detector that detects displacement of the display device with respect to the apparatus main body or detachment of the display device from the apparatus main body, wherein, in a case where the displacement of the display device with respect to the apparatus main body or the detachment of the display device from the apparatus main body is detected by the detector, a screen for receiving the predetermined information from a user is displayed on the display device.

### BRIEF DESCRIPTION OF THE DRAWINGS

An exemplary embodiment of the present invention will be described in detail based on the following figures, wherein:

FIG. 1 is a diagram showing an image forming apparatus to which the exemplary embodiment is applied;

FIG. 2 is a front view of a user interface (UI);

FIG. 3 is a diagram showing a state of a liquid display monitor after it is detached from an apparatus main body of the image forming apparatus;

FIGS. 4A and 4B are diagrams showing examples of a process in detaching the liquid display monitor;

FIGS. 5A and 5B are diagrams showing other examples of the process in detaching the liquid display monitor;

FIG. 6 is a diagram for illustrating connection between the liquid display monitor and the apparatus main body;

FIG. 7 is another diagram for illustrating connection between the liquid display monitor and the apparatus main body;

FIG. 8 is a diagram showing another configuration example of the UI;

FIG. 9 is a diagram showing still another configuration example of the UI; and

FIG. 10 is a diagram in the case where the image forming apparatus is viewed from the direction of arrow X in FIG. 1.

### DETAILED DESCRIPTION

Hereinafter, an exemplary embodiment for practicing the present invention will be described in detail with reference to the attached drawings.

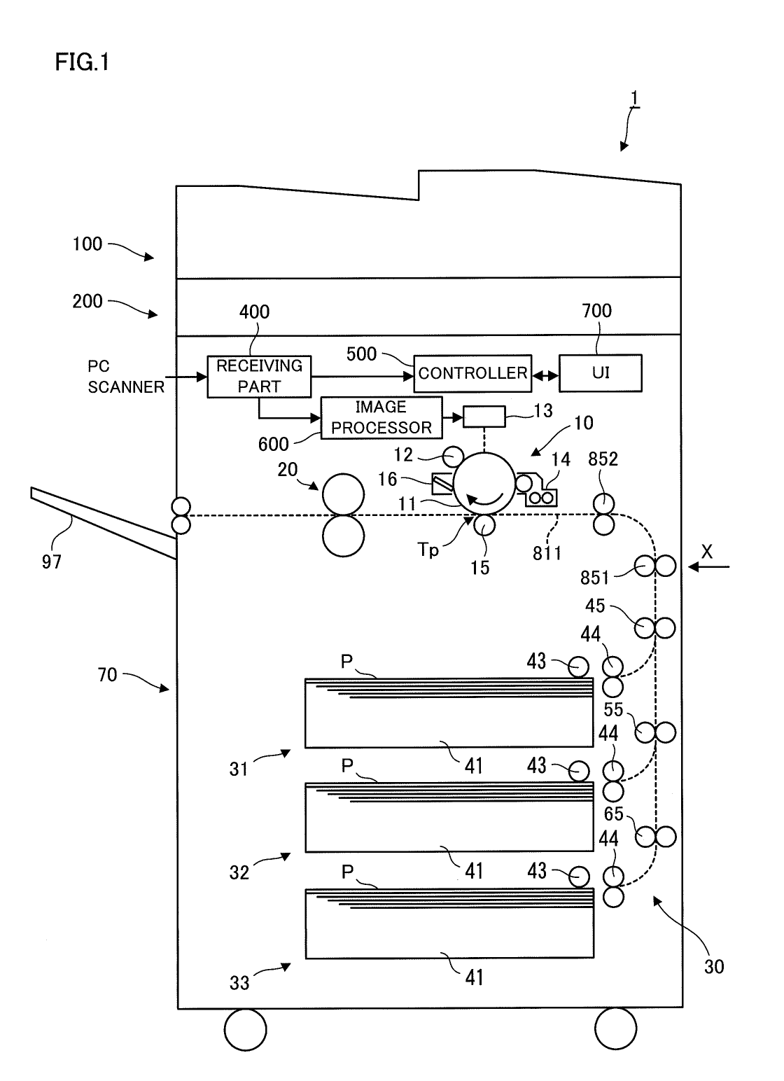

FIG. 1 is a diagram showing an image forming apparatus 1 to which the exemplary embodiment is applied.

The image forming apparatus 1, as an example of an electronic appliance, is provided with an image forming unit 70 that forms an image on a sheet P, a scanner 200 that reads an image by scanning, and a document feeder 100 that feeds a document to the scanner 200.

The image forming unit 70 is provided with an image forming part 10 that forms a toner image on a sheet P, a fixing part 20 that heats and pressurizes the toner image formed on the sheet P by the image forming part 10 to fix the toner image on the sheet P, and a sheet supply part 30 that supplies the sheet P to the image forming part 10.

The image forming part 10 includes a photoconductive drum 11, a charging device 12, an exposure device 13, a developing device 14, a transfer device 15 and a cleaner 16. Of these, the photoconductive drum 11 has a photoconductive layer on an outer circumferential surface thereof and rotates in the direction of an arrow in the figure. The charging device 12 charges the rotating photoconductive drum 11 at a predetermined potential. The exposure device 13 selectively exposes the photoconductive drum 12 that has been charged at the predetermined potential by the charging device 12 to form an electrostatic latent image.

The developing device 14 develops the electrostatic latent image formed on the photoconductive drum 11 with toner to form a toner image. The transfer device 15 electrostatically transfers the toner image formed on the photoconductive drum 11 onto the sheet P supplied by the sheet supply part 30. The cleaner 16 removes the toner or the like that remains on the photoconductive drum 11 after transfer. It should be noted that, hereinafter in this specification, a position that is a part where the photoconductive drum 11 and the transfer device 15 face each other and a part for transferring the toner image on the photoconductive drum 11 onto the sheet P by use of the transfer device 15 is referred to as a transfer part Tp.

The sheet supply part 30 includes a first sheet supply part 31 to a third sheet supply part 33 so as to be capable of supplying the sheets P of different sizes to the image forming part 10. Here, the first sheet supply part 31 to the third sheet supply part 33 are configured similarly.

Taking the first sheet supply part 31 as an example, the first sheet supply part 31 includes a sheet container 41, a pull-in roll 43 and a separation mechanism 44. Of these, the sheet container 41 has a shape of a rectangular parallelepiped and contains sheets inside thereof. The pull-in roll 43 contacts an uppermost sheet of a bundle of sheets contained in the sheet container 41 and forwards the uppermost sheet toward the separation mechanism 44. The separation mechanism 44 is configured with, for example, a feed roll that is rotatably arranged and a retard roll in which rotation is limited, and separates the sheets forwarded by the pull-in roll 43 one by one.

The sheet supply part 30 is provided with a first transport roll 45, a second transport roll 55 and a third transport roll 65. The first transport roll 45 is configured with a pair of roll-like members and further transports the sheet forwarded from the separation mechanism 44 of the first sheet supply part 31 to a downstream side. The second transport roll 55 is also configured with a pair of roll-like members and transports the sheet forwarded from the separation mechanism 44 of the second sheet supply part 32 to the first transport roll 45. Further, the third transport roll 65 is also configured with a pair of roll-like members and transports the sheet forwarded from the separation mechanism 44 of the third sheet supply part 33 to the second transport roll 55.

To a sheet path 811 provided on a downstream side of the first transport roll 45, a pre-registration roll 851 and a registration roll 852 are attached. The pre-registration roll 851 further transports the sheet transported via the first transport roll 45 to the downstream side, and cooperates with the registration roll 852 to perform loop formation. The registration roll 852 stops transporting the sheet by temporary halting and restarts the rotation with adjusted timing, to thereby supply the sheet to the transfer part Tp while performing registration adjustment.

In addition, the image forming apparatus 1 is provided with a receiving part 400 that receives image data from a not-shown personal computer (PC), the scanner 200 or the like. The image forming apparatus 1 is also provided with an image processor 600 that performs image processing on the image data received at the receiving part 400, and thereafter, outputs the image data to the exposure device 13. Further, a user interface (UI) 700 that receives instructions from a user and displays a message or the like to the user is provided. In addition, a controller 500 that controls operations of the image forming part 10, the fixing part 20, the sheet supply part 30 and the UI 700 is also provided.

It should be noted that the controller 500 is configured with a central processing unit (CPU), a read only memory (ROM), a random access memory (RAM) and a hard disk drive (HDD), all of which are not shown in the figure. In the CPU, processing programs for the processes to be described later are executed. In the ROM, various kinds of programs, various kinds of tables, parameters and the like are stored. The RAM is used as a work area or the like during execution of the various kinds of programs by the CPU.

Operations of the image forming apparatus 1 will be described.

In the image forming apparatus 1 of the exemplary embodiment, first, transport of the sheet P by the sheet supply part 30, which is configured with the pull-in roll 43, the separation mechanism 44, the first transport roll 45, the second transport roll 55, the third transport roll 65, the pre-registration roll 851 and the registration roll 852, is started. Specifically, the pull-in roll 43 forwards the sheet P from the sheet container 41 provided in any of the first sheet supply part 31 to the third sheet supply part 33. Subsequently, the sheet P is transported to the transfer part Tp by the pre-registration roll 851, the registration roll 852 and the like.

On the other hand, in the image forming part 10, the surface of the photoconductive drum 11 that has been charged by the charging device 12 is exposed by the exposure device 13, and thereby an electrostatic latent image is formed on the surface of the photoconductive drum 11. Then, the formed electrostatic latent image is developed to be a toner image by the developing device 14. Thereafter, the toner image formed on the photoconductive drum 11 is transferred at the transfer part Tp onto the sheet P transported by the registration roll 852. Then, the sheet P, onto which the toner image has been transferred, is subjected to a fixing process in the fixing part 20. Thereafter, the sheet P is stacked on a sheet stacking part 97 provided outside of the image forming apparatus 1.

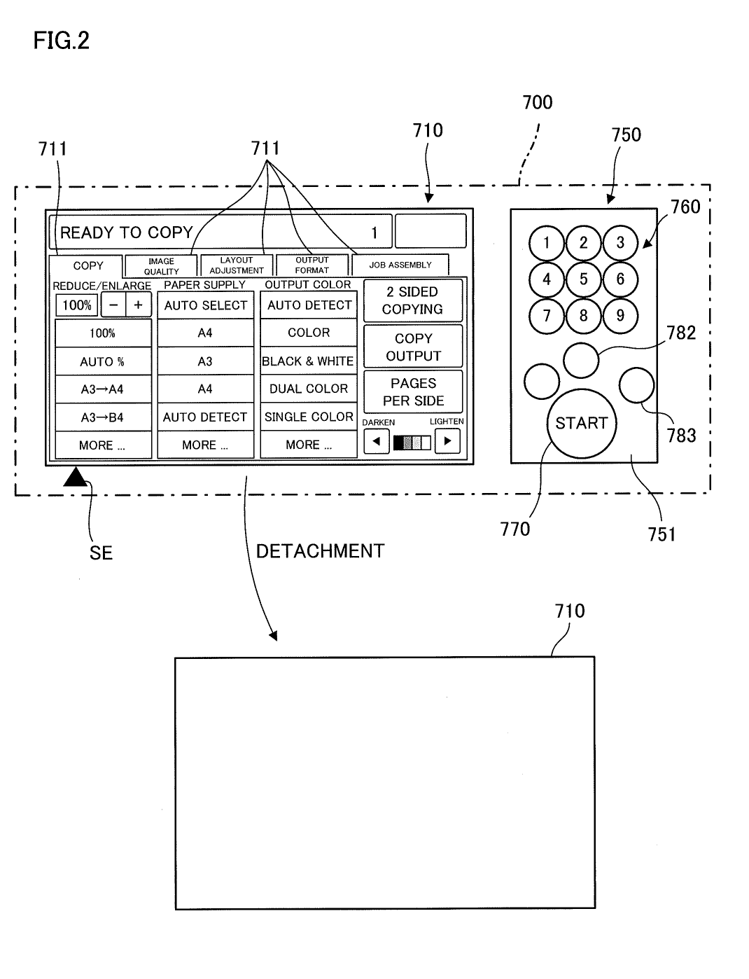

FIG. 2 is a front view of the UI 700.

In the UI 700 of the exemplary embodiment, as shown in the figure, a liquid crystal monitor 710 as an example of a display device is provided. The UI 700 is provided with a hard key 750 that includes plural push buttons pushed by the user when information inputting is performed and functions as a receiving unit that receives predetermined information from the user. It should be noted that the liquid crystal monitor 710 in the exemplary embodiment is configured with a monitor of a touch panel type, and information is inputted to the liquid crystal monitor 710 with the touch of the user on the surface of the panel.

Further, in the exemplary embodiment, the liquid crystal monitor 710 is detachably attached to an apparatus main body of the image forming apparatus 1. In addition, a detecting sensor SE that functions as a detector for detecting detachment of the liquid crystal monitor 710 from the apparatus main body is also provided.

Here, the image forming apparatus 1 is used by various users, and for example, there is a case where a wheelchair user uses the image forming apparatus 1. The wheelchair user has to be situated sideways with respect to the image forming apparatus 1, and it is difficult to maintain a posture in this case. Here, if the liquid crystal monitor 710 can be detached as in the exemplary embodiment, the user is enabled to input information in a more comfortable position.

Moreover, there are some cases where a user is standing in front of the image forming apparatus 1 while copying process or the like is performed by the image forming apparatus 1, and in such cases, another user who wants to use the image forming apparatus 1 cannot operate the image forming apparatus 1. As in the exemplary embodiment, if the liquid crystal monitor 710 is detachable, even in the case where a user is standing in front of the image forming apparatus 1, the other user becomes enabled to perform input of information to the image forming apparatus 1, such as input of a number of copies or a copy mode, by operating the liquid crystal monitor 710 in the detached state.

It should be noted that it is possible to configure the entire UI 700 including the hard key 750 to be detachable from the apparatus main body of the image forming apparatus 1; however, in this case, the UI 700 in the detached state is cumbersome and operability thereof is deteriorated. Accordingly, the exemplary embodiment provides the configuration in which the liquid crystal monitor 710, which is a part of the UI 700, can be detached. It should be noted that control of the liquid crystal monitor 710 may be performed by the controller 500 provided in the apparatus main body of the image forming apparatus 1, or a controller different from the controller 500 may be provided inside the liquid crystal monitor 710 to control the liquid crystal monitor 710.

Here, in the example shown in FIG. 2, a display screen that is displayed in the so-called copy mode is displayed on the liquid crystal monitor 710. In the display screen, five tabs 711 are displayed, and character information such as “copy”, “image quality”, “layout adjustment”, “output format” and “job assembly” are displayed on the respective tabs 711.

By pushing any of the five tabs 711, the user is enabled to perform setting for the item displayed on any of the tabs 711. It should be noted that, in FIG. 2, the tab 711 of “copy” is selected by the user, and accordingly, a display button for enabling “reduce/enlarge”, a display button for enabling “paper supply” and a display button for enabling selection of “output color” are displayed on the display screen. In addition, in the lower right of the display screen, a button used for setting the copy density is displayed.

Next, description will be given to the configuration of the hard key 750.

The hard key 750 is, as shown in FIG. 2, provided with plural push buttons (push portions), which is activated (positioned downward) by being pushed by the user. Moreover, the hard key 750 is provided with a support stage 751 that supports these push buttons from beneath. In the hard key 750 of the exemplary embodiment, a numeric keypad 760 used for inputting numerals is provided. Here, the numeric keypad 760 is provided with push buttons, on top surfaces of which numerals such as “1” to “9” are marked.

Moreover, the hard key 750 is provided with, above the support stage 751 and at a position lower than the numeric keypad 760 in the figure, a start button 770 for receiving instruction from a user for starting a process such as copying. Further, between the numeric keypad 760 and the start button 770, a reset button 782 used for resetting (clearing) information inputted by the user through the numeric keypad 760 is provided. Still further, a stop button 783, which is pushed by the user when the process started by pushing the start button 770 is suspended or ceased, is provided.

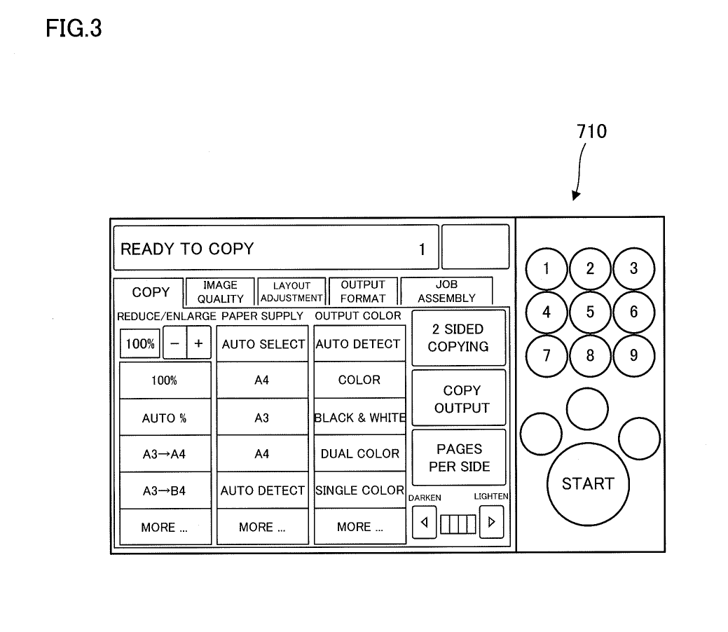

FIG. 3 is a diagram showing a state of the liquid display monitor 710 after it is detached from the apparatus main body of the image forming apparatus 1.

As shown in the figure, when the liquid display monitor 710 is detached, a display screen that has been displayed on the liquid display monitor 710 before it is detached (display screen shown in FIG. 2, sometimes referred to as “normal screen”) is reduced (reduced in the width direction of the screen) to be displayed, and is moved to the left side of the screen.

Then, in the exemplary embodiment, an imaged hard key 750 (hereinafter, referred to as “hard key image”) is displayed at a blank portion generated by moving the display screen of the liquid crystal monitor to the left side. It should be noted that, in the hard key 750 (refer to FIG. 2) provided in the apparatus main body, other than the numeric keypad 760 and the like, push buttons (not shown) such as a power-saving button, which are used at a lower frequency than the numeric keypad 760 and the like, are provided; however, in the exemplary embodiment, part of the push buttons that are used at a higher frequency, such as the numeric keypad 760 and the like is displayed on the liquid crystal monitor 710 when the hard key image is displayed on the liquid display monitor 710. This makes trouble such as poor viewability of the screen in the liquid crystal monitor 710 harder to occur.

It should be noted that, in the exemplary embodiment, when the liquid crystal monitor 710 is detached, a space for displaying the hard key image is formed by scaling down the normal screen as described above; however, the space for displaying the hard key image may be formed by deleting a part of the plural display items included in the normal screen. Moreover, when the hard key image is displayed, actual size imaging of the state of the hard key 750 provided in the apparatus main body of the image forming apparatus 1 may be displayed on the liquid crystal monitor 710 in a full size, or the actual size imaging may be displayed while scaling down the entire actual size imaging.

Moreover, for example, when the hard key image is displayed, an arrangement of the plural provided push buttons may be different from the arrangement of the push buttons actually provided in the apparatus main body. In addition, when the hard key image is displayed, a placing position of the hard key image can be different from the placing position of the actual placing position thereof in the apparatus main body. For example, in the mode shown in FIG. 3, the hard key image is arranged on the right side of the normal screen; however, when the hard key image is displayed, for instance, the hard key image can be displayed horizontally above the normal screen.

It should be noted that, in terms of easiness of operation, an arrangement relation between the liquid display monitor 710 and the hard key 750 in the apparatus main body may coincide with an arrangement relation between the normal screen and the hard key image in the detached liquid display monitor 710.

In the case of the exemplary embodiment, in the apparatus main body, the liquid crystal monitor 710 and the hard key 750 are adjacent each other in the horizontal direction, and the liquid crystal monitor 710 is positioned at the left side of the figure while the hard key 750 is positioned at the right side of the figure as shown in FIG. 2. Also in the liquid crystal monitor 710 after detachment, as shown in FIG. 3, the normal screen and the hard key image are adjacent each other in the horizontal direction, and the normal screen is positioned at the left side of the figure while the hard key image is positioned at the right side of the figure. In the case where arrangements coincide with each other in this manner, in comparison with the case where the arrangements are altered, it becomes easier for the user to operate the liquid crystal monitor 710 after detachment.

Here, in the case where only the screen shown in FIG. 2 (normal screen) is displayed on the liquid crystal monitor 710 when the liquid crystal monitor 710 is detached, there is a possibility that the user has difficulty in inputting information to the image forming apparatus 1. For example, there is a case where, in copying, the user performs inputting of a number of copies; however, if the above-described hard key image is not displayed on the liquid crystal monitor 710, the user is required to operate the hard key 750 provided in the apparatus main body of the image forming apparatus 1. Moreover, for example, when the copying is started, the user is also required to operate the hard key 750 on the apparatus main body.

For this reason, in the exemplary embodiment, when the liquid crystal monitor 710 is detached, the hard key 750 is also displayed after being imaged in addition to the items displayed so far. In this case, an operation part is not separated into two locations of the liquid crystal monitor 710 and the hard key 750 in the apparatus main body, but is organized in one location on the liquid crystal monitor 710.

It should be noted that, in the above description, the process in detaching the liquid crystal monitor 710 is described; and in the case where the detached liquid crystal monitor 710 is attached to the apparatus main body of the image forming apparatus 1 (in the case where the attachment of the liquid crystal monitor 710 is detected by the detecting sensor SE), the hard key image having been displayed on the liquid crystal monitor 710 disappears. Specifically, in the exemplary embodiment, when the controller 500 obtains the detection result that the liquid crystal monitor 710 is attached to the apparatus main body from the detecting sensor SE, the controller 500 deletes the hard key image that has been displayed on the liquid crystal monitor 710.

If the hard key image is still displayed even after the liquid crystal monitor 710 is attached to the apparatus main body of the image forming apparatus 1, there occurs a state where the hard key image and the hard key 750 are adjacent (two items having the same function are arranged in parallel), and thereby it becomes difficult for the user to perform inputting operation. Accordingly, in the exemplary embodiment, as described above, the process for deleting the hard key image is executed in the case where the liquid crystal monitor 710 is attached to the apparatus main body of the image forming apparatus 1. To be described more specifically, in the case where the liquid crystal monitor 710 is attached to the apparatus main body of the image forming apparatus 1, the normal screen that has been reduced in the width direction of the liquid crystal monitor 710 and displayed is restored in the original state (enlarged in the width direction of the liquid crystal monitor 710) as well as the hard key image is deleted.

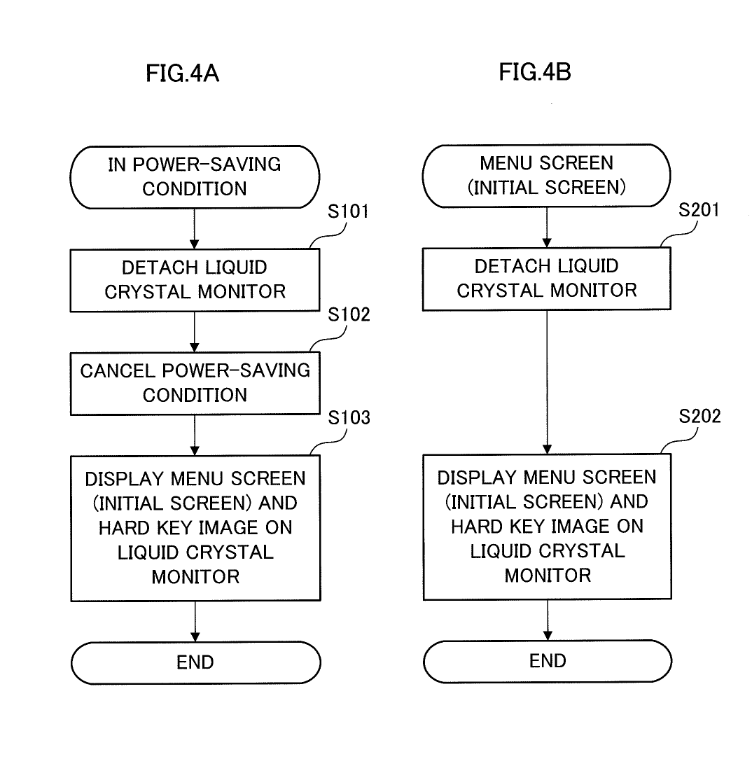

Here, detachment of the liquid crustal monitor 710 from the apparatus main body is performed at various timings. For example, as shown in FIGS. 4A and 4B (FIGS. 4A and 4B are diagrams showing examples of the process in detaching the liquid display monitor 710), there is a case where the liquid crystal monitor 710 is detached in the power-saving condition (step 101), and in such a case, first, the controller 500 obtains the detection result from the detecting sensor SE that the liquid crystal monitor 710 has been detached. Thereafter, the controller 500 performs cancellation of the power-saving condition (step 102), and then, displays a menu screen (initial screen) and the hard key image on the liquid crystal monitor 710 (step 103).

Moreover, as shown in FIG. 4B, there is a case where the liquid crystal monitor 710 is detached when the menu screen (initial screen) has already been displayed on the liquid crystal monitor 710 (step 201), and in such a case, the menu screen (initial screen) is continuously displayed and the hard key image is additionally displayed on the liquid crystal monitor 710 (step 202).

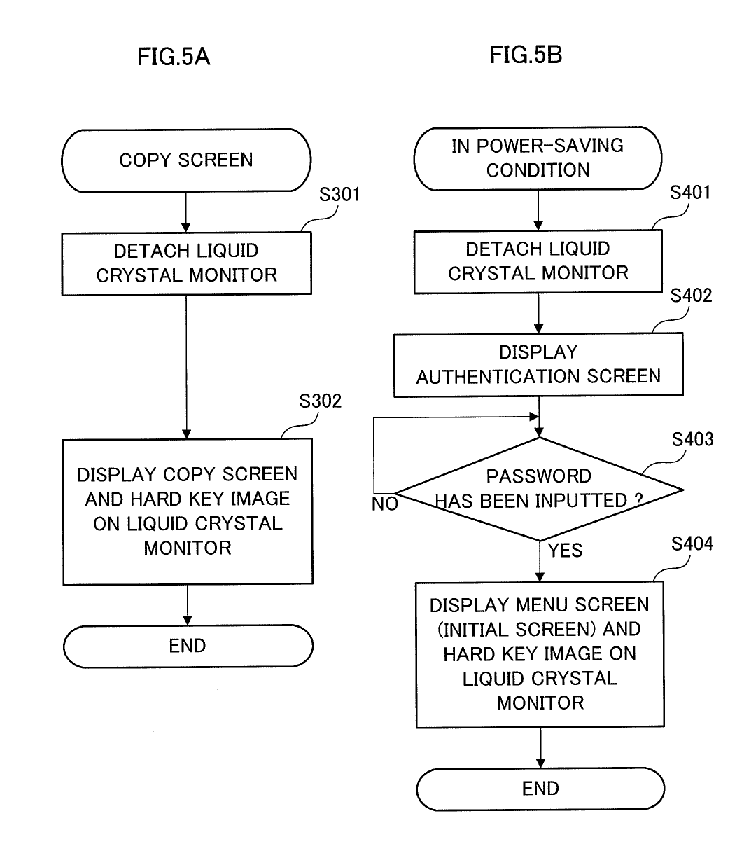

With reference to FIGS. 5A and 5B (diagrams showing other examples of the process in detaching the liquid display monitor 710), other examples of the process will be described.

As described above using FIG. 2, there is a case where the liquid crystal monitor 710 is detached when the “copy screen” to be displayed in copying performed by the user is displayed (refer to step 301 in FIG. 5A). In this case, as shown in FIG. 3, the copying screen is continuously displayed on the liquid crystal monitor 710, and the hard key image is additionally displayed (step 302).

Moreover, the process shown in FIG. 5B can also be performed. In this processing example, the liquid crystal monitor 710 is detached in the power-saving condition (step 401). Thereafter, an authentication screen used for user authentication (the screen prompting the user to input a password) is displayed on the liquid crystal monitor 710 (step 402). Then, it is confirmed whether the password has been inputted or not (step 403), and if it is confirmed that the password has been inputted, the menu screen (initial screen) and the hard key image are displayed on the liquid crystal monitor 710 (step 404).

It should be noted that inputting of a password performed by the user after step 402 may be performed through the hard key 750 in the apparatus main body, or may be performed through the liquid crystal monitor 710 upon displaying the hard key image on the liquid crustal monitor 710.

It should be noted that, in the hard key image displayed on the liquid crystal monitor 710 in the above-described steps 103, 202, 302 and 404, only the push buttons related to the normal screen (display screens such as the menu screen and the copying screen) displayed on the liquid crystal monitor 710 may be displayed. For example, when the screen prompting the user to input the number of copies is displayed as the normal screen, it is possible to display only the numeric keypad and a clear button while omitting the start button or the stop button.

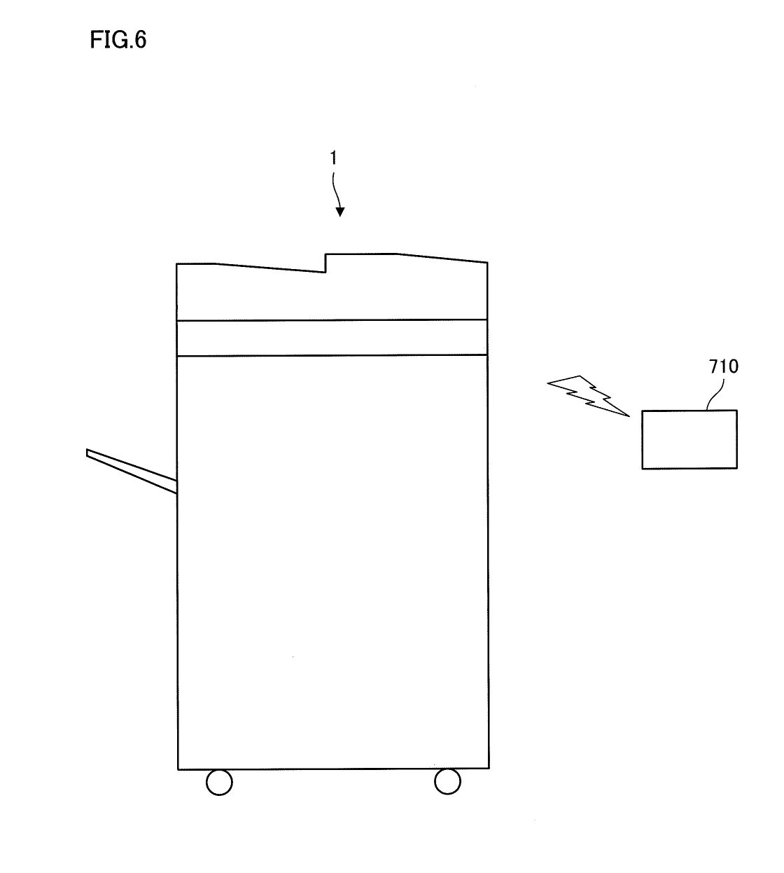

It should be noted that, as shown in FIG. 6 (diagram for illustrating connection between the liquid display monitor 710 and the apparatus main body), the liquid crystal monitor 710 detached from the apparatus main body of the image forming apparatus 1 and the apparatus main body can be connected via a wireless communication circuit. As the wireless communication circuit, a circuit according to already existing systems such as wireless fidelity (Wi-Fi, a registered trademark in Japan) and Bluetooth (registered trademark in Japan) can be provided.

It should be noted that, in the case where the liquid crystal monitor 710 and the apparatus main body are connected via the wireless communication circuit, the apparatus may be configured so that at least one of the liquid crystal monitor 710 and the apparatus main body sounds an alert or a voice if the liquid crystal monitor 710 is apart from the apparatus main body at a predetermined distance. If such a process is performed, theft of the liquid crystal monitor 710 hardly occurs. Moreover, for example, it becomes possible to keep the liquid crystal monitor 710 within a range where communication between the liquid crystal monitor 710 and the apparatus main body is available. It should be noted that whether the liquid crystal monitor 710 is apart from the apparatus main body at a predetermined distance or not can be determined based on, for example, intensity of a signal in communication.

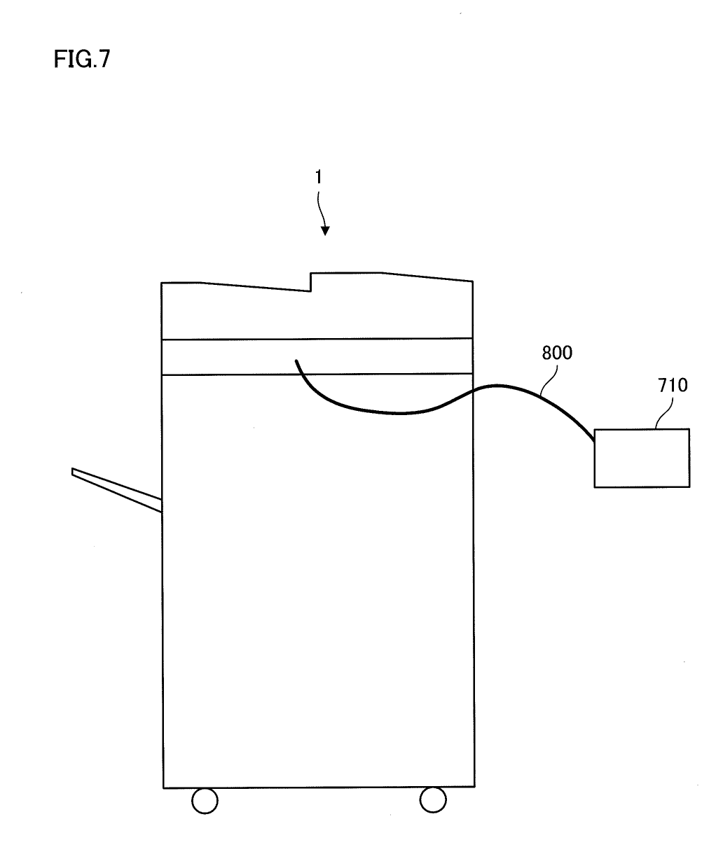

In addition, as shown in FIG. 7 (another diagram for illustrating connection between the liquid display monitor 710 and the apparatus main body), the liquid crystal monitor 710 detached from the apparatus main body of the image forming apparatus 1 and the apparatus main body may be connected via a wire by use of a cable 800. It should be noted that, in the case where the liquid crystal monitor 710 and the apparatus main body are connected via the cable 800, a spool mechanism for winding up the loose cable 800 may be provided in the apparatus main body.

It should be noted that, in the above description, display examples on the liquid crystal monitor 710 when the user inputs information have been described; however, after a process such as copying is started, progress of the process may be displayed on the liquid crystal monitor 710. In the case of performing such a displaying process, the user becomes enabled to check on the progress, for example, at his or her own desk without going to the apparatus main body of the image forming apparatus 1.

Here, so far, it has been described that the liquid crystal monitor 710 is detachably attached, and in the case where the liquid crystal monitor 710 is detached, the hard key image is displayed on the liquid crystal monitor 710 together with the normal screen. Incidentally, the hard key image can be displayed even in a mode in which the liquid crystal monitor 710 is able to be tilted by a tilting mechanism. More specifically, a detecting sensor (not shown) detecting that the liquid crystal monitor 710 is tilted is provided in advance, and when the liquid crystal monitor 710 is tilted beyond a predetermined angle, it is possible to display the hard key image.

Here, sometimes, there is difficulty in viewing the display screen depending upon an angle of the light incident on the liquid crystal monitor 710; in such a case, if the angle of the liquid crystal monitor 710 can be changed, it becomes easier to see the display screen. Moreover, in the case where the liquid crystal monitor 710 is displaced along the vertical direction or the liquid crystal monitor 710 is further displaced so that the display surface of the liquid crystal monitor 710 faces downward, it becomes possible to confirm the display on the liquid crystal monitor 710 from beneath. In such a case, it becomes easier to see the screen for the wheelchair user. Also in the case where the liquid crystal monitor 710 is tilted and displaced, by displaying the hard key image on the liquid crystal monitor 710, the user is enabled to easily input information to the image forming apparatus 1.

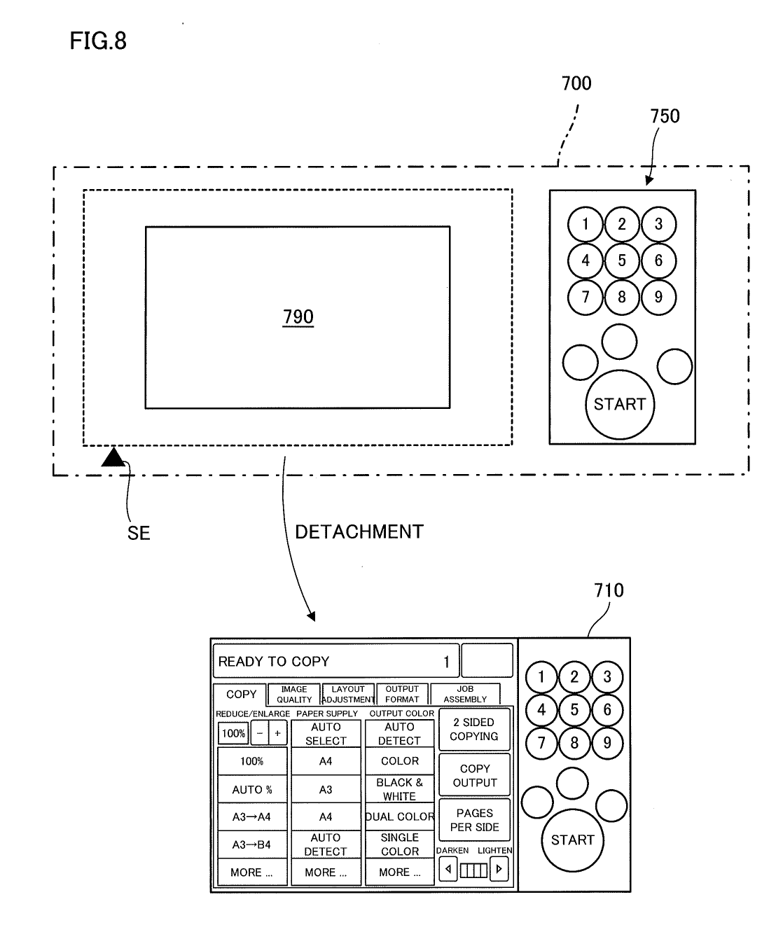

Moreover, as shown in FIG. 8 (diagram showing another configuration example of the UI 700), in addition to the above-described liquid crystal monitor 710, a second liquid crystal monitor 790 that functions as a second display device may be provided to the apparatus main body of the image forming apparatus 1. As described above, in the image forming apparatus 1, there is a case where a user is stand-by in front of the image forming apparatus 1 to wait for the sheets to be outputted from the image forming apparatus 1. In addition, on this occasion, there is also a case where the liquid crystal monitor 710 is detached by the other user to input information.

By the way, if the liquid crystal monitor 710 is detached by the other user, it becomes impossible for the stand-by user who is stand-by in front of the image forming apparatus 1 to grasp the progress of the process such as copying carried out by himself (or herself). Here, if the second liquid crystal monitor 790 is provided as described above, the aforementioned stand-by user is enabled to grasp the progress even though the liquid crystal monitor 710 is detached.

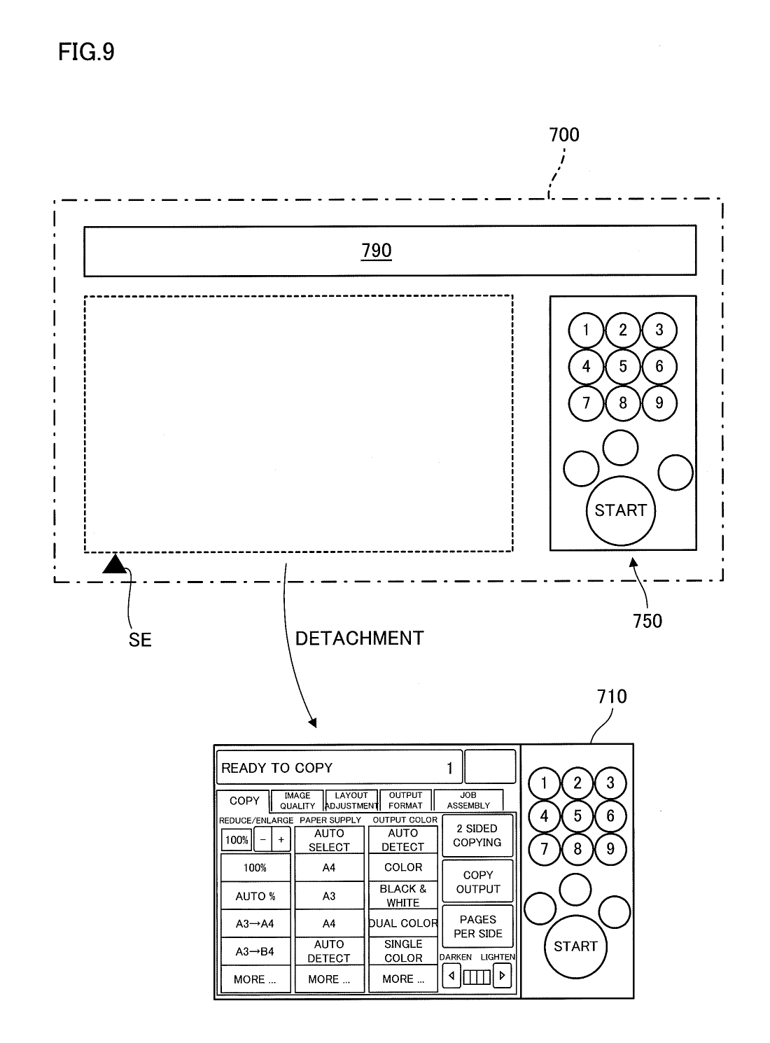

It should be noted that the second liquid crystal monitor 790 may be smaller (the display area thereof may be smaller) than the liquid crystal monitor 710 because an object thereof is to display information. Moreover, as shown in FIG. 8, the second liquid crystal monitor 790 may be located behind the liquid crystal monitor 710 to appear when the liquid crystal monitor 710 is detached, or, as shown in FIG. 9 (diagram showing still another configuration example of the UI 700), the second liquid crystal monitor 790 may be provided at a location different from the liquid crystal monitor 710.

Moreover, though description has been omitted above, a process of rejecting the operations by the user to the hard key 750 during the time when the liquid crystal monitor 710 is detached (a process of determining the operations by the user to the hard key 750 in the apparatus main body to be invalid) may be performed. Specifically, the apparatus may be configured so that, in the case where the hard key 750 is operated by the user when the liquid crystal monitor 710 is attached, a predetermined process such as an image forming operation is performed by the controller 500 that functions as a processing unit; however, in the case where the hard key 750 is operated by the user during the time when the liquid crystal monitor 710 is detached, the predetermined process is not performed.

On the other hand, the apparatus may be configured to receive the operations to the hard key 750 performed in the state where the liquid crystal monitor 710 is detached. It should be noted that, in the case of performing such a process, the operations to the hard key 750 in the apparatus main body may be received as instructions from the user for the process performed by the image forming apparatus 1 at that time (hereinafter, referred to as “running process”), and the operations to the liquid crystal monitor 710 may be received as instructions from the user for the process planned to be performed next to the running process (the process other than the running process).

Here, if the instructions inputted by the user via the liquid crystal monitor 710 are received as instructions for the running process, there is a possibility that a process against the intention of the user performing the running process, such as suspending or ceasing the running process, is performed. For example, as described above, there is a case where the stand-by user is stand-by in front of the image forming apparatus 1, whereas the liquid crystal monitor 710 is detached by the other user and operated by the other user. In such a case, if the apparatus is configured to receive the instructions through the liquid crystal monitor 710 as the instructions for the running process, when, for instance, the stop button included in the hard key image is pushed, the above-described running process is stopped.

In addition, for example, the apparatus may be configured not to display the push buttons possibly affecting the running process, such as the stop button, on the liquid crystal monitor 710 (hard key image), or, though allowing such buttons to be displayed, the apparatus may be configured not to receive operations (inputting) to the displayed push buttons. Moreover, for example, during the time when the running process is performed, a process for completely rejecting the operations to the liquid crystal monitor 710 (inputting to the liquid crystal monitor 710) can be performed.

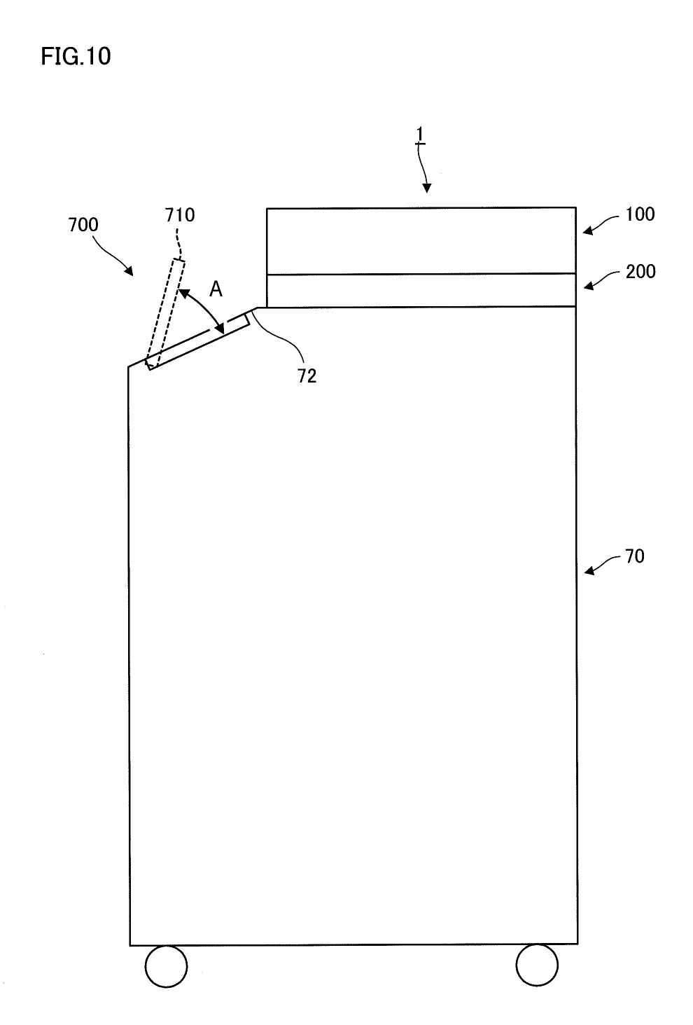

It should be noted that, in the case of configuration in which the liquid crystal monitor 710 is able to be tilted by the tilting mechanism or the like, a detecting sensor (not shown) for detecting that the liquid crystal monitor 710 is tilted may be provided to display the hard key image when the liquid crystal monitor 710 is tilted more than a predetermined angle. To be described specifically, as shown in FIG. 10 (diagram in the case where the image forming apparatus 1 is viewed from the direction of arrow X in FIG. 1), the hard key image may be displayed when the angle A formed by an outer surface 72 of the apparatus main body and the liquid crystal monitor 710 exceeds the predetermined angle.

If the apparatus is configured so that the hard key image is displayed without any exception when the liquid crystal monitor 710 is tilted only a little, the hard key image and the hard key 750 are arranged in the adjacent state in the UI 700. In other words, two items, the hard key image and the hard key 750, enter into the user's sight. In such a case, items having the same function are arranged side by side, and it becomes difficult to perform operations conversely. On the other hand, if the apparatus is configured to display the hard key image when the angle of the liquid crystal monitor 710 exceeds the predetermined angle, the arrangement in which the hard key image and the hard key 750 are adjacent each other rarely occurs.

Moreover, in the above description, the case where the hard key image is displayed without any exception when the liquid crystal monitor 710 is detached or tilted has been described; however, the hard key image may be displayed in the case where an inquiry about whether the hard key image is to be displayed or not is made to the user through the liquid crystal monitor 710, for example, and permission from the user is obtained. In other words, the apparatus may be configured to allow the user to select whether or not the hard key image is displayed. Some users dislike the display screen of the liquid crystal monitor 710 to be narrowed by displaying the hard key image; however, if the selectable configuration is available, it becomes possible to prevent the display screen from being narrowed.

Moreover, in the above description, the image forming apparatus 1 has been taken as an example; however, the configuration and processes described above are applicable to other electronic appliances in which a display device can be detached from an apparatus main body.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment as chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic appliance comprising:
an apparatus main body;
a display device that is provided in the apparatus main body, the display device being displaceable with respect to the apparatus main body or being detachable from the apparatus main body;
a receiving unit that is provided in the apparatus main body to receive predetermined information from a user, the receiving unit including a plurality of push portions that are activated when being pushed by a user; and
a detector that detects displacement of the display device with respect to the apparatus main body or detachment of the display device from the apparatus main body,
wherein, in a case where the displacement of the display device with respect to the apparatus main body or the detachment of the display device from the apparatus main body is detected by the detector, a screen for receiving the predetermined information from a user is displayed on the display device.

2. The electronic appliance according to claim 1, wherein, in the case where the displacement of the display device with respect to the apparatus main body or the detachment of the display device from the apparatus main body is detected by the detector, an item imaging a state of the receiving unit is displayed on the display device as the screen for receiving the predetermined information from a user.

3. The electronic appliance according to claim 1, wherein, prior to detection of the displacement of the display device with respect to the apparatus main body or the detachment of the display device from the apparatus main body by the detector, a predetermined screen is displayed on the display device, and in the case where the displacement of the display device with respect to the apparatus main body or the detachment of the display device from the apparatus main body is detected by the detector, the predetermined screen is reduced.

4. The electronic appliance according to claim 1, wherein the apparatus main body is provided with a second display device that is smaller than the display device.

5. The electronic appliance according to claim 1, wherein, in a case where the displacement of the display device with respect to the apparatus main body or the detachment of the display device from the apparatus main body is detected by the detector, and permission from a user is obtained, the display device displays the screen for receiving the predetermined information from a user.

6. The electronic appliance according to claim 1, further comprising:
a processor that, when the predetermined information is received by the receiving unit, performs a process corresponding to the predetermined information,
wherein, in a case where the predetermined information is received by the receiving unit during a time when the display device is displaced or the display device is detached from the apparatus main body, the processor does not perform the process corresponding to the predetermined information.

7. An electronic appliance comprising:
an apparatus main body;
a receiving unit that is provided in the apparatus main body to receive predetermined information from a user, the receiving unit including a plurality of push portions that are activated when being pushed by a user;
a display device that is provided in the apparatus main body and displays a screen for receiving the predetermined information from a user, the display device being attachable to the apparatus main body or being displaceable with respect to the apparatus main body; and
a detector that detects attachment of the display device to the apparatus main body or displacement of the display device with respect to the apparatus main body,
wherein, in a case where the attachment of the display device to the apparatus main body or the displacement of the display device with respect to the apparatus main body is detected by the detector, the screen for receiving the predetermined information from a user is deleted from the display device.

8. A method for controlling an electronic appliance including: an apparatus main body; a display device that is provided in the apparatus main body, the display device being displaceable with respect to the apparatus main body or being detachable from the apparatus main body; a receiving unit that is provided in the apparatus main body to receive predetermined information from a user, the receiving unit including a plurality of push portions that are activated when being pushed by a user; and a detector that detects displacement of the display device with respect to the apparatus main body or detachment of the display device from the apparatus main body, the method comprising:
obtaining a detection result by the detector; and
in a case where the detection result that the displacement of the display device with respect to the apparatus main body or the detachment of the display device from the apparatus main body is obtained, displaying a screen for receiving the predetermined information from a user on the display device.

9. A non-transitory computer readable medium storing a program causing a computer to execute a process for controlling an electronic appliance including: an apparatus main body; a display device that is provided in the apparatus main body, the display device being displaceable with respect to the apparatus main body or being detachable from the apparatus main body; a receiving unit that is provided in the apparatus main body to receive predetermined information from a user, the receiving unit including a plurality of push portions that are activated when being pushed by a user; and a detector that detects displacement of the display device with respect to the apparatus main body or detachment of the display device from the apparatus main body, the process comprising:
obtaining a detection result by the detector; and
in a case where the detection result that the displacement of the display device with respect to the apparatus main body or the detachment of the display device from the apparatus main body is obtained, displaying a screen for receiving the predetermined information from a user on the display device.

10. A non-transitory computer readable medium storing a program causing a computer to execute a process for controlling an electronic appliance including: an apparatus main body; a receiving unit that is provided in the apparatus main body to receive predetermined information from a user, the receiving unit including a plurality of push portions that are activated when being pushed by a user; a display device that is provided in the apparatus main body and displays a screen for receiving the predetermined information from a user, the display device being attachable to the apparatus main body, or being displaceable with respect to the apparatus main body; and a detector that detects attachment of the display device to the apparatus main body, or displacement of the display device with respect to the apparatus main body, the process comprising:
obtaining a detection result by the detector; and
in a case where the detection result that the attachment of the display device to the apparatus main body or the displacement of the display device with respect to the apparatus main body is obtained, deleting the screen for receiving the predetermined information from a user, which is displayed on the display device, from the display device.
